(19) United States
(12) Patent Application Publication
(10) Pub. No.: US 2018/0297801 A1
(43) Pub. Date: Oct. 18, 2018

(54) PAPER SHEET STORAGE MECHANISM AND CONTROL METHOD THEREFOR

(71) Applicant: FUJITSU FRONTECH LIMITED, Tokyo (JP)

(72) Inventors: Hayato Minamishin, Inagi (JP); Mitsutaka Nishida, Inagi (JP); Tatsuya Shimamura, Inagi (JP); Naoto Ikeda, Inagi (JP); Yutaka Namikawa, Inagi (JP)

(21) Appl. No.: 16/015,918

(22) Filed: Jun. 22, 2018

Related U.S. Application Data
(63) Continuation of application No. PCT/JP2016/051938, filed on Jan. 22, 2016.

(51) Int. Cl. B65H 5/28; G07D 11/00; B65H 29/00

(52) U.S. Cl. CPC B65H 5/28; B65H 29/006; G07D 11/0021

(57) ABSTRACT

A control method of a paper sheet storage mechanism that can wind or feed out tape while preventing the tape from becoming loose while maintaining a certain level of tension of the tape. A drum control unit controls a drum driving source in such a manner that a tape speed detected by a tape speed detection unit is constant. When a drum winds a paper sheet, a reel driving source rotatably drives a pair of reels in the direction of feeding out a pair of pieces of tape. A reel control unit controls the reel driving source in such a manner that reeling speeds detected by reeling speed detection units are lower than a tape speed. Further, rotation shafts of the reels are provided with a torque limiter that causes the rotation shafts to idle when a torque greater than a prescribed value is applied to the rotation shafts.

### CROSS-REFERENCE TO RELATED APPLICATION

This application is a continuation of PCT application PCT/JP2016/051938 filed on Jan. 22, 2016 and designated the U.S., the entire contents of which are incorporated herein by reference.

### FIELD

The present invention is related to a paper sheet storage mechanism and a control method therefor.

### BACKGROUND

Banknote processing machines included in Automated Teller Machines (ATMs) etc. are provided with a temporarily-holding unit for temporarily holding (storing) banknotes that have been conveyed on a conveyance path and outputting the banknotes that have been held temporarily to a conveyance path. Paper sheet storage mechanisms employed by temporarily-holding units are classified into stacker types, which store paper sheets by stacking them, and roll types, which store paper sheets by sandwiching the paper sheets on their top and bottom surfaces between pieces of tape so as to wind the paper sheets.

As a conventional technique, there is for example a paper sheet storage mechanism of a roll type that uses a plurality of pieces of tape in order to store and feed out banknotes as paper sheets.

As illustrated in FIG. 4A, a paper sheet storage mechanism that uses four pieces of tape is provided with a drum 10 that winds or feeds out the four pieces of tape 2a and 2b, and two pairs of reels 31 and 32 that respectively feed out and wind the pieces of tape 2a and 2b toward the drum 10, the pieces of tape working as pairs each consisting of two pieces of tape. Also, a driving source (not illustrated) such as a motor etc. is provided between the two pairs of the reels 31 and 32 so as to transmit the driving force from the driving source to the drum 10 and the two pairs of the reels 31 and 32 through a transmission mechanism (not illustrated).

Explanations will be given for the operations of a conventional paper sheet storage mechanism by referring to the conceptual diagram of the conventional paper sheet storage mechanism illustrated in FIG. 4B.

When storing a banknote, the driving source (not illustrated) makes the drum rotate on a rotation shaft 10a in the direction of winding the pieces of tape 2a and 2b. With the driving force transmitted through the transmission mechanism (not illustrated), the pieces of tape 2a and 2b are fed out from the reels 31 and 32. A banknote 1 is sandwiched between idler rollers 3 and 4, and is stored by being wound on the drum 10 in a state in which it is sandwiched between the pieces of tape 2a and 2b.

FIG. 5A illustrates a state in which the first banknote 1 is being stored on the drum 10. The drum 10 is rotating on the rotation shaft 10a in the direction of winding the pieces of tape 2a and 2b, and the pieces of tape 2a and 2b have started being fed out from the reels 31 and 32 via idler rollers 3, 4 and 5. In FIG. 5A, the banknote 1 has not been stored yet.

FIG. 5B illustrates an operation state in which a plurality of banknotes 1 are being stored on the drum 10 by being sandwiched between the pieces of tape 2a and 2b. When the operation state of the banknote storing proceeds from FIG. 5A to FIG. 5B, the tape 2a and 2b and the banknotes 1 that have been wound increase in amount, also increasing the diameter of the drum 10.

FIG. 6A illustrates an operation state in which a plurality of banknotes 1 are being fed out by the drum 10 rotating in the reverse direction, the plurality of banknotes 1 having been stored on the drum 10 while being sandwiched between the pieces of tape 2a and 2b. When feeding out banknotes, the driving source (not illustrated) makes the reels 31 and 32 rotate in the direction of winding the pieces of tape 2a and 2b. The driving mechanism (not illustrated) transmits the driving force, and the drum 10 rotates in the feeding-out direction. Thereby, the pieces of tape 2a and 2b and the banknotes 1 sandwiched between the pieces of tape 2a and 2b are fed out from the drum 10. FIG. 6B illustrates a state in which the drum 10 has fed out the last banknote 1. When the operation state of the feeding out of banknotes has proceeded from FIG. 6A to FIG. 6B, the pieces of tape 2a and 2b and the banknotes 1 that have been wound on the drum 10 decrease in amount, also decreasing the diameter of the drum 10.

For the above paper sheet storage mechanism of a roll type, there are for example Patent Documents 1 and 2, which will be described below, and other documents. Patent Document 1 proposes a low-cost and highly reliable banknote storage/output device that is provided with scraper guides on both sides of a scraper and multi-stage banknote-outputting guides on both sides of a conveyance roller, that can store and output even small-sized banknotes or banknotes that involve undesirable conditions such as bending or curling tendencies etc., in order to handle banknotes of different sizes. Also, Patent Document 2 proposes a paper sheet storage mechanism provided with a transmission mechanism that transmits a rotation driving force to the reel from the driving shaft of the motor body that is arranged in the winding roller.
Patent Document 1: Japanese Laid-open Patent Publication No. 2001-118113
Patent Document 2: International Publication Pamphlet No. WO2011/036783

As described above, an increase in the amount of the banknotes 1 that have been stored together with the pieces of tape 2a and 2b on the circumference of the drum 10 increases the diameter of the drum 10 and decreases the diameters of the reels 31 and 32.

An increase in the amount of the stored banknotes 1 increases the amount of the pieces of tape 2a and 2b and the banknotes 1 sandwiched between the pieces of tape 2a and 2b on the drum 10 circumferentially, which also increases the inertia moment of the drum 10. Newton's second law for rotary motion can be given by the formula below, where the inertia moment is I, the rotary torque is T and the angular velocity is d²θ/dt².

T=I×(d²θ/dt²) formula (1)

While an increase in the amount of the pieces of tape 2a and 2b and the banknotes 1 that have been wound circumferentially on the drum 10 increases the value of inertia moment I, the value of the angular acceleration (d²θ/dt²) becomes smaller, as expressed by formula (1), because consistent rotary torque T is applied from the drum driving source.

However, the banknote storage/output device proposed in Patent Document 1 only includes a drum driving source and does not include an independent reel driving source. Also, the paper sheet storage mechanism proposed in Patent Document 2 transmits a driving force to the rotation shaft of the reel through a transmission mechanism from a driving shaft directly connected to the drum driving source (motor) located on the drum side.

Accordingly, in the paper sheet storage mechanisms of a roll type disclosed in Patent Documents 1 and 2, an increase in the amount of the pieces of tape 2a and 2b and the banknotes 1 that have been wound circumferentially on the drum 5 increases the value of inertia moment I, making it impossible to achieve sufficient angular acceleration (d²θ/dt²) due to insufficient rotary torque T. When, particularly, a high-speed winding process is to be performed, sufficient angular acceleration (d²θ/dt²) cannot be achieved due to insufficient rotary torque T. As a result of this, an increase in the amount of the stored banknotes 1 increases the loads of the rotary torque of the motor etc., and particularly when the speed of winding is high, the loads become heavier, making it difficult to perform winding or rewinding while preventing the tape from becoming loose and while maintaining a certain level of tension in the tape.

In view of this, it is an object of the present invention to provide a paper sheet storage mechanism and a control method therefor that can perform winding or feeding out while preventing the tape from becoming loose and while maintaining a certain level of tension in the tape even when the amount of stored paper sheets has increased or when the speed of winding is high.

### SUMMARY

The paper sheet storage mechanism according to a first aspect of the present invention is a paper sheet storage mechanism that sandwiches a paper sheet between pieces of tape and stores the paper sheet, the paper sheet storage mechanism including a drum configured to wind the paper sheet sandwiched between the pieces of tape so as to store the paper sheet or to rewind the stored paper sheet so as to feed out the paper sheet, a drum driving source configured to rotatably drive the drum, a reel configured to feed out the tape when the drum winds the paper sheet and to wind the tape fed out from the drum when the paper sheet is fed out from the drum, a reel driving source configured to rotatably drive the reel, a tape speed detection unit configured to detect a speed of the tape, and a drum control unit configured to control the drum driving source in accordance with information from the tape speed detection unit, wherein the reel includes a reeling speed detection unit that detects at least one reeling speed, and a reel control unit that controls the reel driving source when storing or feeding out the paper sheet, and the reel includes, in a reel rotation shaft, a torque limiter that idles when a torque equal to or greater than a prescribed value is applied.

A control method for the paper sheet storage mechanism according to a second aspect of the present invention is a control method for a paper sheet storage mechanism wherein a drum driving source rotatably drives a drum in a direction in which a paper sheet is sandwiched between pieces of tape, is wound, and is stored, a drum control unit controls the drum driving source in accordance with information from a tape speed detection unit that detects a speed of tape, and when the drum winds the paper sheet a reel driving source rotatably drives a reel in a direction of feeding out the tape, a reel control unit controls the reel driving source in such a manner that a reeling speed is lower than the tape speed, the reeling speed being detected by a reeling speed detection unit that detects a speed of the reel, and a torque limiter included in a reel rotation shaft of the reel causes the reel rotation shaft to idle when a torque equal to or greater than a prescribed value is applied to the reel rotation shaft.

The object and advantages of the embodiment will be realized and attained by means of the elements and combinations particularly pointed out in the claims.

It is to be understood that both the foregoing general description and the following detailed description are exemplary and explanatory and are not restrictive of the embodiment.

### BRIEF DESCRIPTION OF DRAWINGS

FIG. 1 is a structure diagram illustrating the outline of the paper sheet storage mechanism of an embodiment of the present invention;

FIG. 2 is a functional block diagram of the paper sheet storage mechanism illustrated in FIG. 1;

FIG. 3 is an overview diagram illustrating the configuration of an automated teller machine including the paper sheet storage mechanism according to an embodiment of the present invention;

FIGS. 4A and 4B explain the structure of the paper sheet storage mechanism according to a conventional technique;

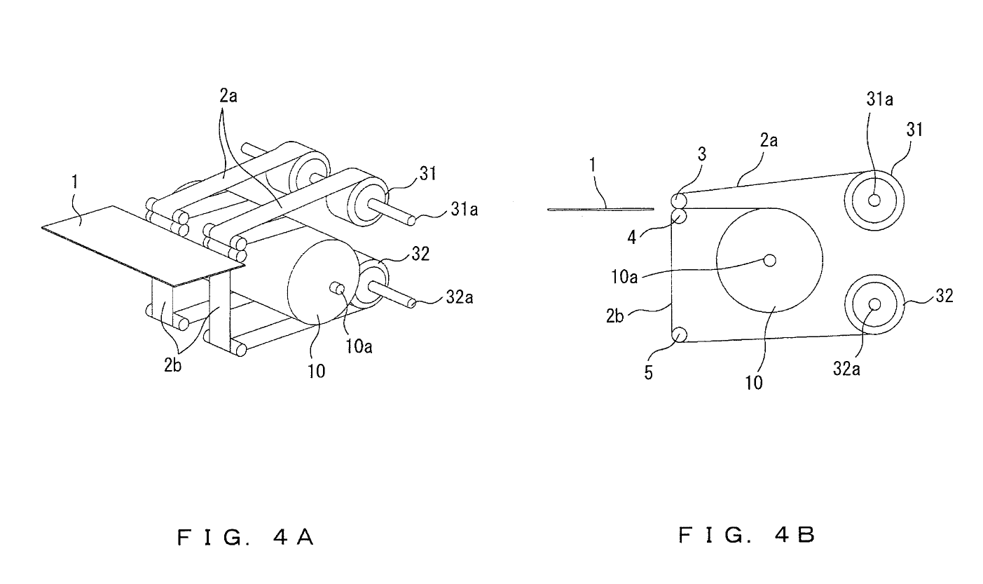

FIGS. 5A and 5B explain a winding operation of paper sheets in the paper sheet storage mechanism according to a conventional technique;

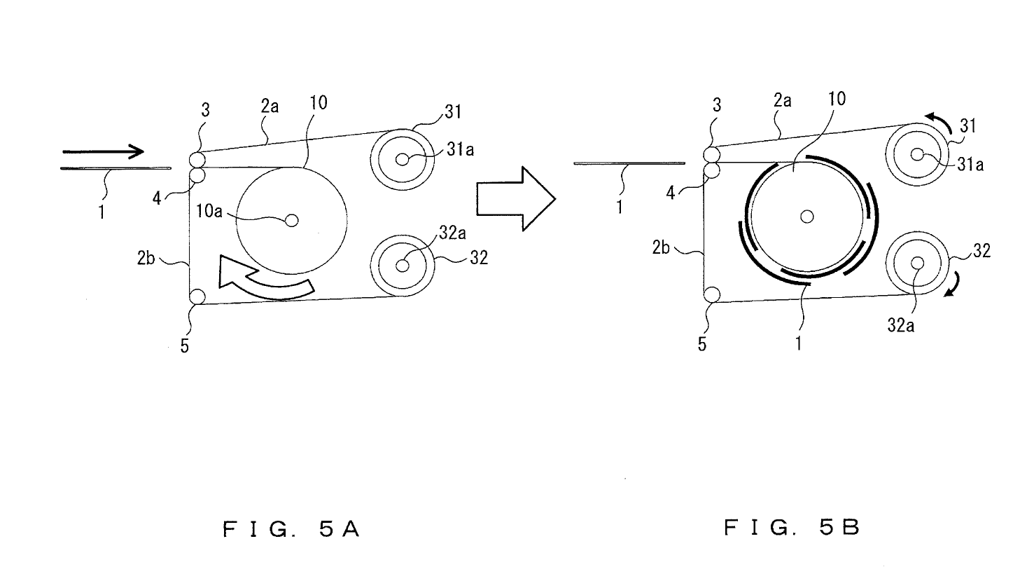

FIGS. 6A and 6B explain a feeding out operation of paper sheets in the paper sheet storage mechanism according to a conventional technique;

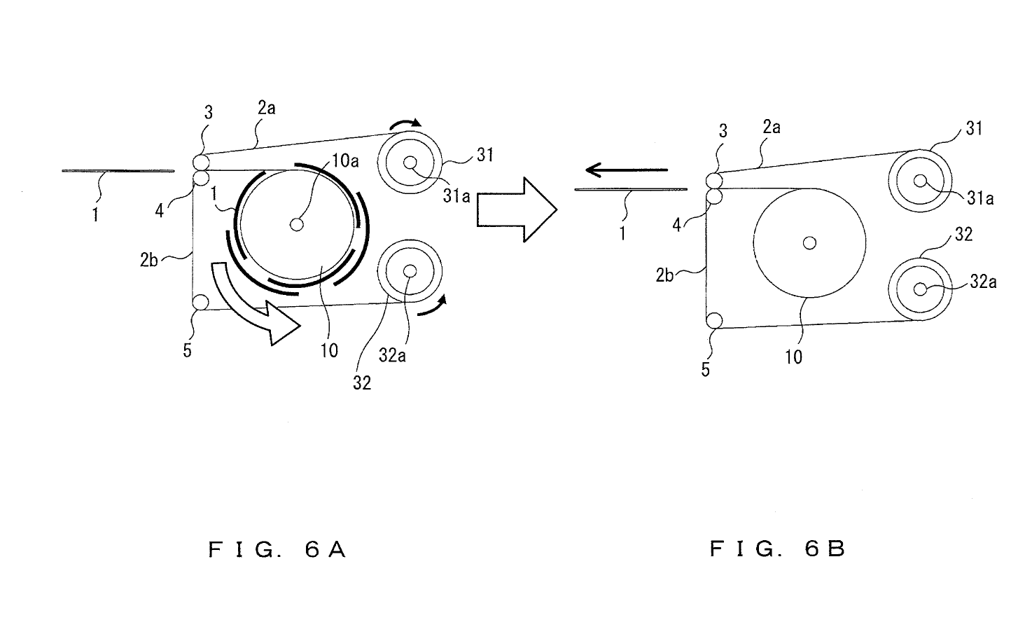

FIGS. 7A and 7B explain a winding operation of paper sheets in the paper sheet storage mechanism according to an embodiment of the present invention;

FIGS. 8A and 8B explain a feeding out operation of paper sheets in the paper sheet storage mechanism according to an embodiment of the present invention;

FIG. 9 illustrates an operation performed in a state in which paper sheets are not stored in the paper sheet storage mechanism according to an embodiment of the present invention;

FIG. 10 illustrates an operation performed in a state in which half the storable amount of paper sheets have been stored in the paper sheet storage mechanism according to an embodiment of the present invention; and

FIG. 11 illustrates an operation in a state in which the maximum storable amount of paper sheets have been stored in the paper sheet storage mechanism according to an embodiment of the present invention.

### DESCRIPTION OF EMBODIMENTS

Hereinafter, explanations will be given for the embodiment of the present invention by referring to the drawings.

Note in the explanations of the present embodiment that while banknotes are used as an example of paper sheets, the scope of the invention is not limited to banknotes and includes securities, gift certificates, etc.

(Configuration of Embodiment)

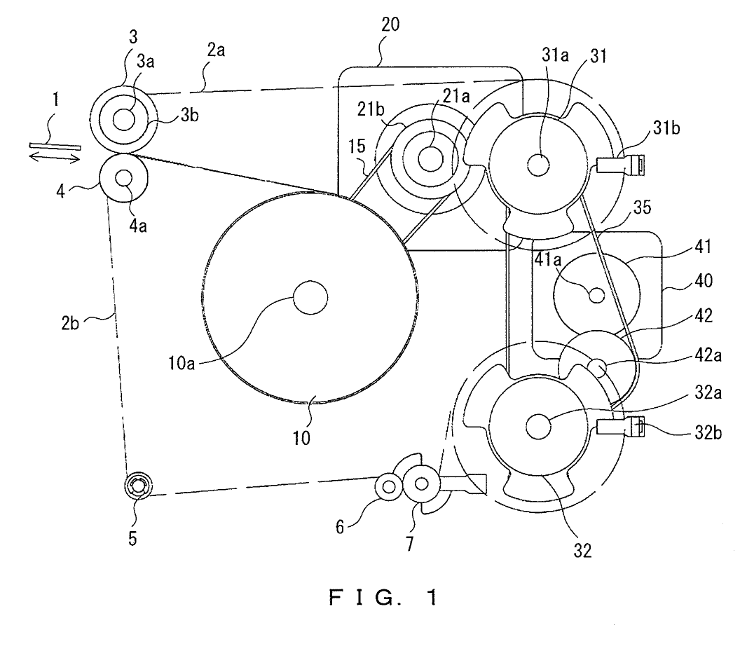

Explanations will be given for the configurations of the embodiment of the present invention by referring to FIG. 1 through FIG. 3.

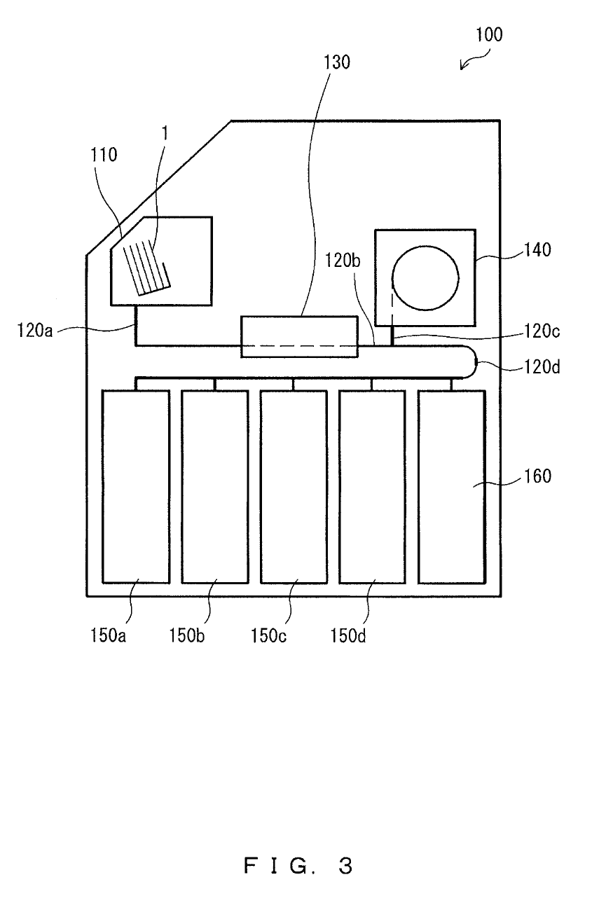

FIG. 3 is an overview diagram illustrating the configuration of an automated teller machine including a paper sheet storage mechanism according to an embodiment of the present invention. An automated teller machine 100 is a device that inputs and outputs the banknote 1 as a paper sheet. The automated teller machine 100 includes a banknote input/output unit 110 that receives input and output of the banknote 1 and a differentiating unit 130 that determines whether the banknote 1 is authentic or counterfeit. The banknote input/output unit 110 and the differentiating unit 130 are connected by a conveyance path 120a that conveys the banknotes 1.

The automated teller machine 100 further includes a temporarily-holding unit 140 that temporarily holds (stores) the banknote 1 that has been conveyed from the differentiating unit 130, four storage boxes 150a through 150d that store the banknotes 1 according to the types of the banknotes 1, and a retrieval box 160 for retrieving the banknotes 1 that cannot be used for transactions because they are counterfeit or damaged. The differentiating unit 130 and the temporarily-holding unit 140 are connected by conveyance paths 120b and 120c. Further, the temporarily-holding unit 140 is connected to the storage boxes 150a through 150d and to the retrieval box 160 via conveyance paths 120c and 120d.

The banknote 1 that has been input through the banknote input/output unit 110 is stored in the temporarily-holding unit 140 through the conveyance path 120a, the differentiating unit 130 and the conveyance paths 120b and 120c. The paper sheet storage mechanism according to the present invention is embedded in the temporarily-holding unit 140.

FIG. 1 is a structure diagram illustrating the outline of the paper sheet storage mechanism of an embodiment of the present invention.

The paper sheet storage mechanism includes the drum 10 and a pair of the reels 31 and 32, the drum 10 winding and storing the banknote 1 by sandwiching it between a pair of the pieces of tape 2a and 2b and rewinding and feeding out the banknote 1 that has been stored by being sandwiched between the pair of the pieces of tape 2a and 2b, and the pair of the reels 31 and 32 feeding out the pieces of tape 2a and 2b when the drum 10 winds the banknote 1, and winding the pieces of tape 2a and 2b that have been fed out from the drum 10 when the banknote 1 is fed out from the drum 10.

When the drum driving source 20 consisting of a motor etc. applies rotary torque to a driving shaft 21a in the clockwise or counterclockwise direction, a drive roller 21b rotatably fixed to the driving shaft 21a rotates. The pulley 21b of the drum driving source 20 and a pulley (not illustrated) of the drum 10 are connected by a drive belt 15. The drive belt 15 transmits rotary torque, applied by the drum driving source 20, to the rotation shaft 10a so as to rotate the drum 10 on the rotation shaft 10a in the clockwise or counterclockwise direction.

The drum 10 and the reel 31 are connected by the tape 2a via an idler roller 3. Clockwise rotations of the drum 10 on the rotation shaft 10a cause counterclockwise rotations of the reel 31 on its rotation shaft 31a.

The drum 10 and the reel 32 are connected by the tape 2b via three idler rollers 4 through 6 and a tape speed detection unit 7. The tape speed detection unit 7 detects the tape speed of the tape 2b by for example reading the number of the rotations of the roller that is pressed on the surface of the tape 2b. Clockwise rotations of the drum 10 on the rotation shaft 10a cause counterclockwise rotations of the reel 32 on its rotation shaft 32a.

A reel driving source 40 consists of a motor etc., and rotatably drives the pair of the reels 31 and 32. When the reel driving source 40 applies counterclockwise or clockwise rotary torque to a drive shaft 41a, a drive gear (drive rotation body) 41 fixed to the drive shaft 41a rotates a gear (drive transmission rotation body) 42 on a shaft 42a. Rotations of the gear (drive transmission rotation body) 42 transmit rotary torque to the pair of the reels 31 and 32 via a drive belt 35.

The reels 31 and 32 in the pair have reeling speed detection units 31b and 32b, respectively. The reeling speed detection unit 31b is a unit that detects the linear speed of the tape (tape speed) when the reel 31 rotates, and the reeling speed detection unit 32b is a unit that detects the tape speed when the reel 32 rotates. Note that the reeling speed detection units 31b and 32b may be provided to one of the reels 31 and 32.

The paper sheet storage mechanism includes a drum control unit, a reel control unit and a torque limiter, which are not illustrated in FIG. 1.

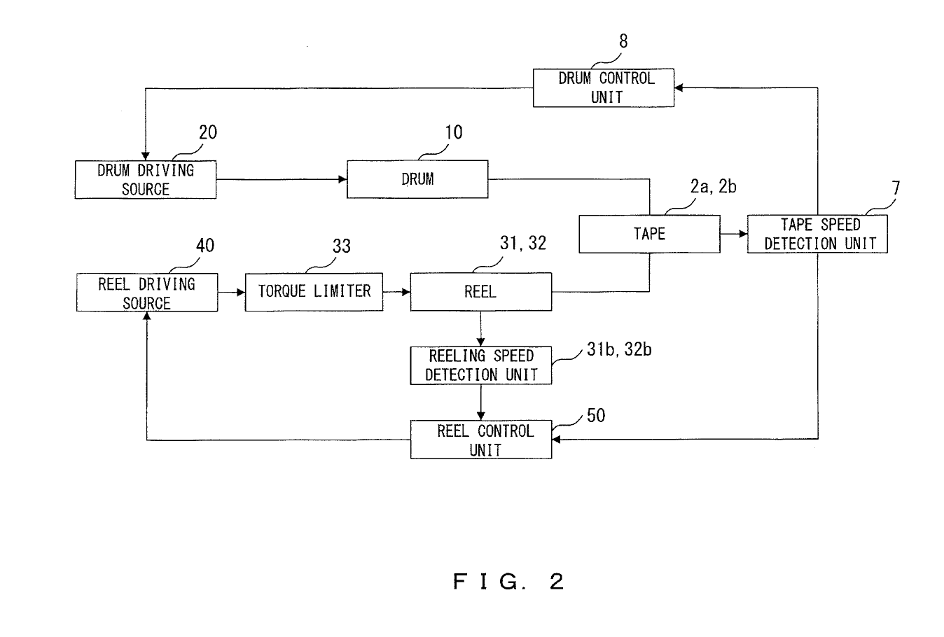

FIG. 2 is a functional block diagram of the paper sheet storage mechanism, and illustrates a drum control unit 8, a torque limiter 33 and a reel control unit 50, which are not illustrated in FIG. 1.

By referring to FIG. 2, explanations will be given for the functions of the drum control unit 8, the torque limiter 33 and the reel control unit 50.

The drum control unit 8 is a unit that controls the drum driving source 20 in accordance with information from the tape speed detection unit 7. The drum control unit 8 controls the drum driving source 20 in such a manner that the tape speed detected by the tape speed detection unit 7 is constant.

The reel control unit 50 is a unit that controls, on the basis of the tape speed detected by the tape speed detection unit 7 and the reeling speeds detected by the reeling speed detection units 31b and 32b, the reel driving source 40 in such a manner that the pieces of tape 2a and 2b have a certain level of tension.

When the drum 10 stores the banknotes 1, the drum driving source 20 rotates the drum 10 in the direction of winding the pieces of tape 2a and 2b. The drum control unit 8 control the drum driving source 20 in such a manner that the tape speed detected by the tape speed detection unit 7 is constant.

The reel control unit 50 performs deacceleration control on the reel driving source 40 in such a manner that the reeling speeds detected by the reeling speed detection units 31b and 32b are lower than the tape speed detected by the tape speed detection unit 7. As described above, when speed deacceleration control is performed on the reel driving source 40 in such a manner that the reeling speeds are lower than the tape speed, the drum 10 winds the pieces of tape 2a and 2b while maintaining them in a pulled state. The reel control unit 50 performs speed deacceleration control in such a manner that the pieces of tape 2a and 2b are wound on the drum 10 while being pulled at a certain level; however when the pieces of tape 2a and 2b are pulled with too large a force, problems such as extension of the pieces of tape 2a and 2b occur.

In order to prevent such problems, the torque limiter 33 is provided via a torsion spring (not illustrated) between the reels 31 and 32 and the rotation shafts 31a and 32a. The torque limiter 33 has a function of causing the rotation shafts 31a and 32a to idle when a rotary torque equal to or greater than a prescribed value is applied to the reel rotation shafts 31a and 32a.

When the drum 10 feeds out the banknote 1, the reel control unit 50 performs acceleration control on the reel driving source 40 in such a manner that the reeling speeds detected by the reeling speed detection units 31b and 32b are higher than the tape speed detected by the tape speed detection unit 7. As described above, when acceleration control is performed on the reel driving source 40 in such a manner that the reeling speeds are higher than the tape speed, the reels 31 and 32 wind the pieces of tape 2a and 2b while maintaining them in a pulled state.

The reel control unit 50 performs acceleration control in such a manner that the reels 31 and 32 wind the pieces of tape 2a and 2b while maintaining them in a pulled state, however when the pieces of tape 2a and 2b are pulled with too large a force, problems such as extension of the pieces of tape 2a and 2b occur.

In order to prevent such problems, the torque limiter 33 is provided via a torsion spring (not illustrated) between the reels 31 and 32 and the rotation shafts 31a and 32a. The torque limiter 33 has a function of causing the rotation shafts 31a and 32a to idle when a rotary torque equal to or greater than a prescribed value is applied to the reel rotation shafts 31a and 32a.

The reel control unit 50 controls the reel driving source 40 in such a manner that the pieces of tape 2a and 2b are in a state of being pulled and the torque limiter 33 causes the rotation shafts 31a and 32a of the reels 31 and 32 to idle if a rotary torque equal to or greater than a prescribed value is applied to the rotation shafts 31a and 32a, and thereby it is possible to wind or rewind the pieces of tape 2a and 2b while preventing the tape from becoming loose and while maintaining a certain level of tension of the tape.

(Operation of Embodiment)

Explanations will be given for the operation of an embodiment of the present invention by categorizing the operation into (I) a winding operation, (II) a feeding out operation, and (III) an operation in a state in which banknotes are stored in different storage amounts.

(I) Winding Operation

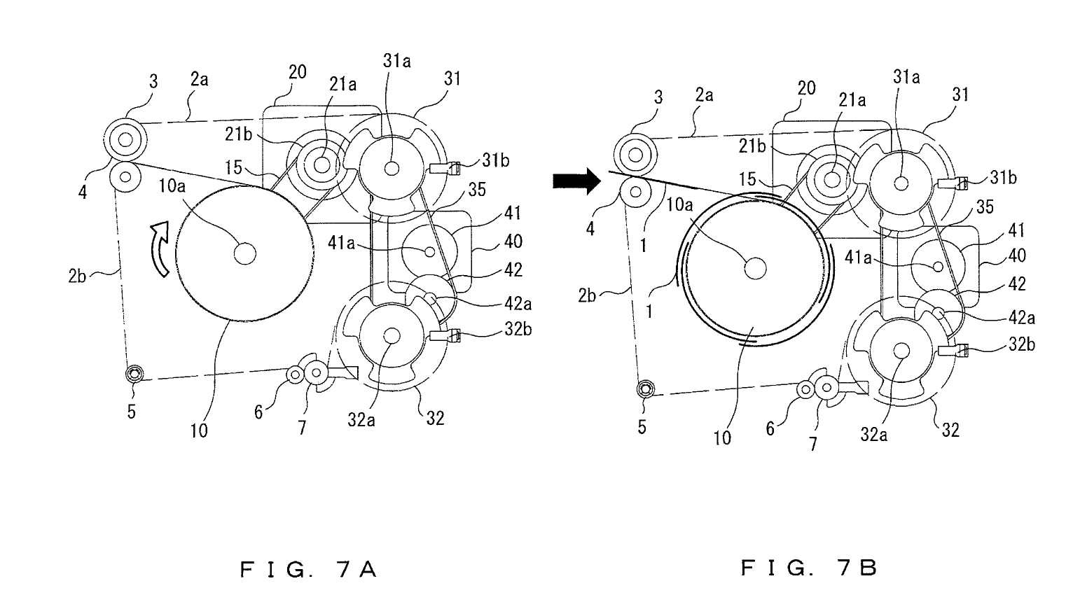

FIG. 7A and FIG. 7B explain a winding operation of paper sheets in the paper sheet storage mechanism according to an embodiment of the present invention. FIG. 7A illustrates the moment when winding of paper sheets is started, and the paper sheets have not yet been stored. FIG. 7B illustrates a state in which paper sheets are being wound and stored on the drum 10 by being sandwiched between the pieces of tape 2a and 2b, and a plurality of paper sheets have been stored.

First, by referring to FIG. 1 through FIG. 3, explanations are given for a winding operation of the banknotes 1 as paper sheets based on FIG. 7A and FIG. 7B.

The drum driving source 20 and the drum 10 are connected by the drive belt 15. When winding the banknotes 1, the pulley 21b of the drum driving source 20 rotates on the driving shaft 21a, and thereby the drum 10 rotates in the clockwise direction. The end faces of the pieces of tape 2a and 2b are connected to the drum 10, and thereby the pieces of tape 2a and 2b are wound on the drum 10.

In this operation, the tape speed detection unit 7 measures the speed of the tape 2 by using an encoder (not illustrated). The drum control unit 8 illustrated in FIG. 2 controls the rotation speed of the drum 10 in accordance with the measured tape speed in such a manner that the speed is equal to the conveyance speed of the banknotes 1 on a portion immediately before the temporarily-holding unit 140 illustrated in FIG. 3.

The pieces of tape 2a and 2b are output from the reels 31 and 32, and thereby the reels 31 and 32 themselves rotate. When winding banknotes, the rotation speeds of the reels 31 and 32 gradually become higher because the decrease in the amount of remaining tape reduces a diameter of the reels 31 and 32. Then, the reeling speed detection units 31b and 32b detect the speeds of the reels 31 and 32. The reel control unit 50 performs deacceleration control on the reel driving source 40 in such a manner that the reeling speeds detected by the reeling speed detection units 31b and 32b are lower than the tape speed detected by the tape speed detection unit 7. The speed difference caused by this operation is canceled by the idling that occurs when a torque equal to or greater than a prescribed value is applied to a torque limiter 35 embedded in the rotation shafts 31a and 32a of the reels 31 and 32.

Also, by controlling the tape speed in such a manner that it becomes as close to the reeling speeds as possible, the slippage amount is reduced for the torque limiter 35, leading to a longer lifetime for the torque limiter 35. Also, by controlling the relative speed between the tape speed and the reeling speeds so as to make it lower, loads per unit of angular velocity are reduced, making it easier to store paper sheets at a high speed.

(II) Feeding Out Operation

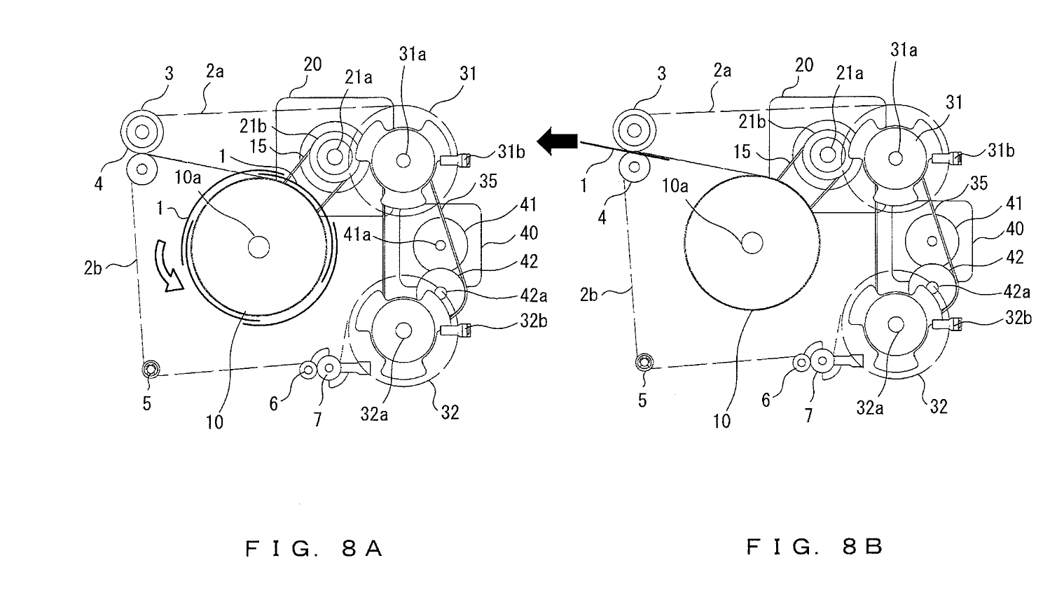

FIGS. 8A and 8B explain a feeding out operation of paper sheets in the paper sheet storage mechanism according to an embodiment of the present invention. FIG. 8A illustrates an operation performed while paper sheets are being fed out, and FIG. 8B illustrates a moment when a last paper sheet is fed out.

By referring to FIG. 1 and FIG. 2, explanations will be given for a feeding out operation of the banknotes 1 based on FIG. 8A and FIG. 8B.

When the reel driving source 40 applies a driving force to the gear (drive rotation body) 41, the gear (drive transmission rotation body) 42 rotates, and the rotary torque transmitted via the drive belt 35 rotates the pair of the reels 31 and 32 in the direction of winding the pieces of tape 2a and 2b. The reel driving source 40 first performs control in such a manner that the rotations of the rotation shafts 31a and 32a of the reels 31 and 32 start at a speed that is slightly higher than the calculated maximum reeling speed. Meanwhile, the drum driving source 20 rotates the drum 10 on the driving shaft 21a of the drum in the direction of feeding out the pieces of tape 2a and 2b so that the pieces of tape 2a and 2b and the banknotes 1 are output.

The drum control unit 8 controls the drum driving source 20 in accordance with information from the tape speed detection unit 7. For example, the drum control unit 8 controls the drum driving source 20 in such a manner that the tape speed detected by the tape speed detection unit 7 is constant. Meanwhile, the reel control unit 50 controls the reel driving source 40 in such a manner that the reeling speeds are higher than the tape speed.

In actuality, because the reels 31 and 32 can only wind tape in an amount that can be fed out from the drum driving source 20, the reels 31 and 32 and the rotation shafts 31a and 32a slip via the torque limiter 33.

Performing control in such a manner that the reeling speeds are higher than the tape speed causes a speed difference between the rotation speeds of the rotation shafts 31a and 32a and the reeling speeds. When the torque caused by this speed difference becomes equal to or greater than a prescribed value, the torque limiter 33 idles so that the speed difference is canceled. In this operation, the reeling speeds are detected by the reeling speed detection units 31b and 32b so as to make the numbers of the rotations of the rotation shafts 31a and 32a of the reels close to the numbers of the rotations of the reels 31 and 32, and thereby the slippage amount of the torque limiter 33 can be minimized.

(III) The Operation in a State in Which Banknotes are Stored in Different Storage Amounts

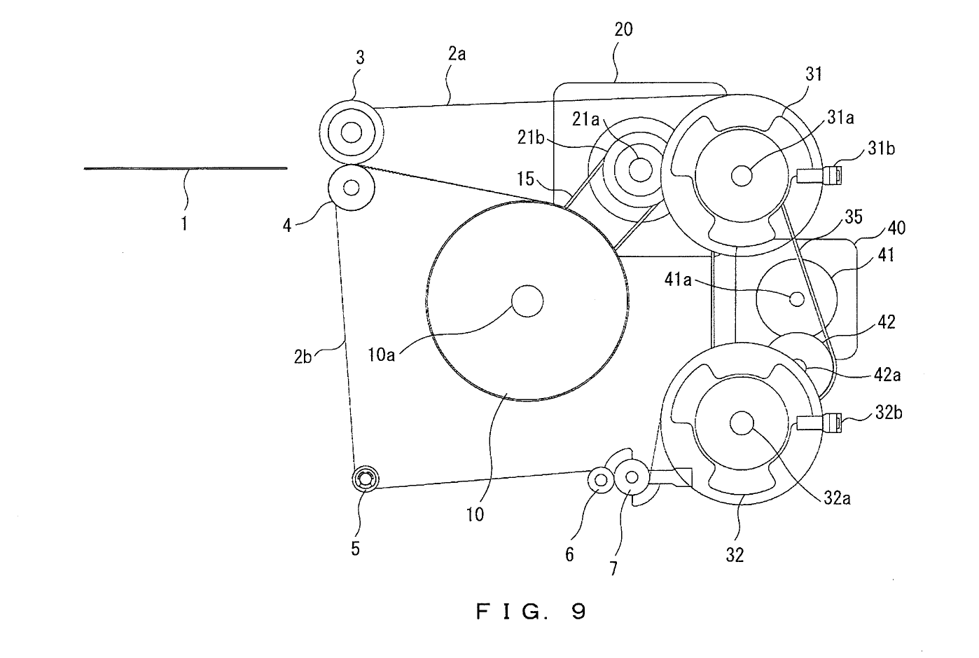

FIG. 9 illustrates an operation performed in a state in which paper sheets are not stored in the paper sheet storage mechanism according to an embodiment of the present invention.

FIG. 9 illustrates a state in which pieces of tape 2a and 2b have been wound on the reels 31 and 32 almost entirely and the pieces of tape 2a and 2b have not been wound on the drum 10. In this state, the drum 10 is smallest in diameter and the reels 31 and 32 are greatest in diameter. In order to make the tape speed constant while winding or feeding out the pieces of tape 2a and 2b in this state, control has to be performed in such a manner that the angular velocity of the drum 10, having a smaller diameter, is made higher and the angular velocities of the reels 31 and 32, having greater diameters, are made lower.

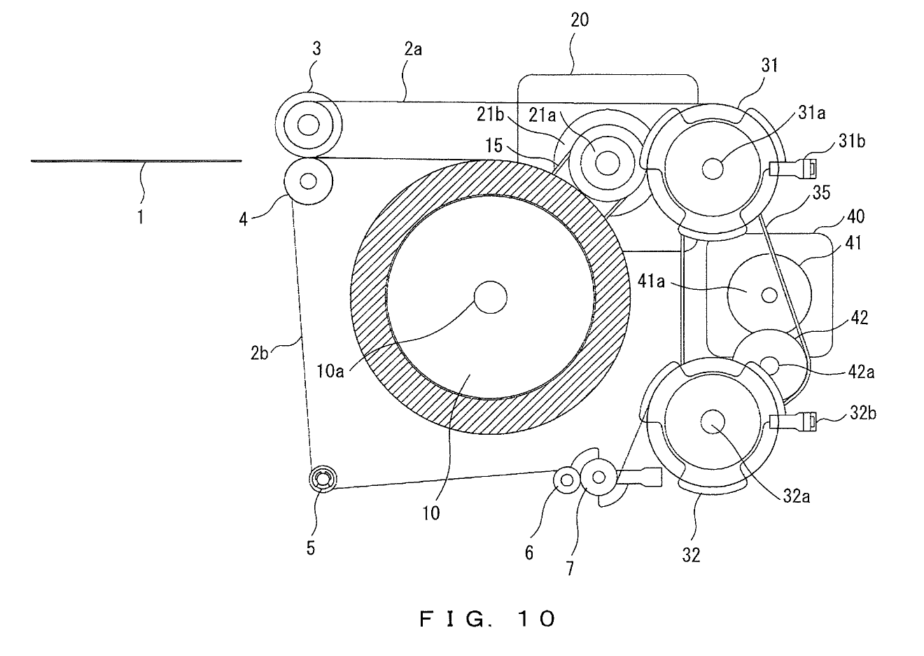

FIG. 10 illustrates an operation performed in a state in which half the storable amount of paper sheets have been stored in the paper sheet storage mechanism according to an embodiment of the present invention.

FIG. 10 illustrates a state in which the pieces of tape 2a and 2b have been wound on the reels 31 and 32 and the drum 10 for half the entire portion of the tape. In order to make the tape speed constant while winding or feeding out the pieces of tape 2a and 2b in this state, control has to be performed in such a manner that the angular velocities of the reels 31 and 32 and the drum 10 are intermediate.

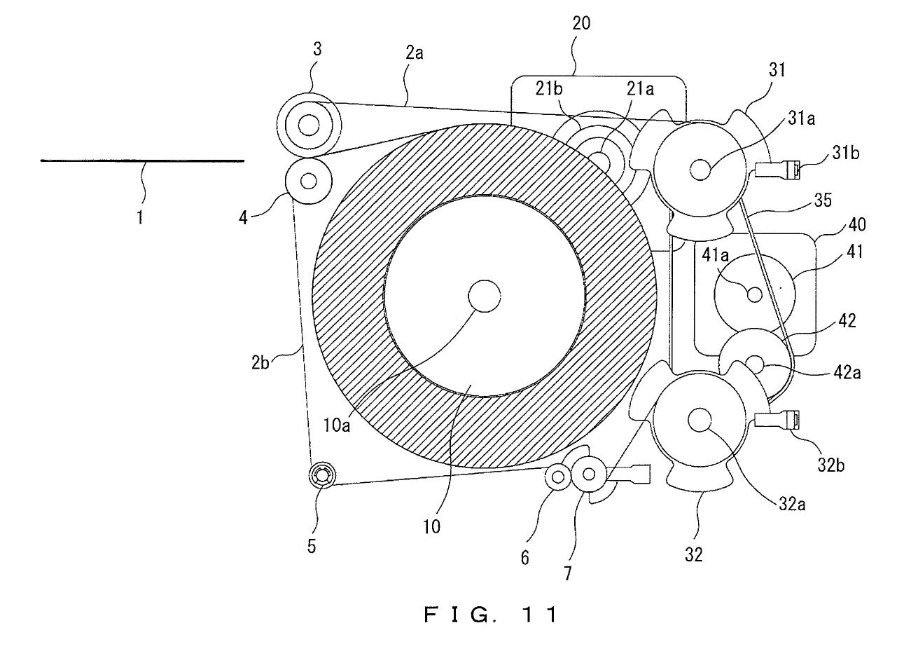

FIG. 11 illustrates an operation in a state in which the maximum storable amount of paper sheets have been stored in the paper sheet storage mechanism according to an embodiment of the present invention.

Further, FIG. 11 illustrates a state in which the pieces of tape 2a and 2b have been wound on the drum 10 almost entirely and the pieces of tape 2a and 2b have not been wound on the reels 31 and 32. In order to make the tape speed constant while winding or feeding out the pieces of tape 2a and 2b in this state, control has to be performed in such a manner that the angular velocity of the drum 10, having a greater diameter, is made lower and the angular velocities of the reels 31 and 32, having smaller diameters, are made higher.

As explained by referring to FIG. 9 through FIG. 11 above, the angular velocities of the reels 31 and 32 and the drum 10 are controlled in such a manner that the tape speed is constant in response to a state in which the pieces of tape 2a and 2b are wound on the reels 31 and 32 and the drum 10. This control makes it possible to reduce the speed difference between the reeling speeds and the tape speed. By reducing the speed difference, the slippage amount of the torque limiter 33, which when torque applied to the rotation shafts 31a and 32a of the reels 31 and 32 becomes equal to or greater than a prescribed value, can be minimized.

(Effects of Embodiment)

In the paper sheet storage mechanism according to an embodiment of the present invention, the torque limiter 33 causes the rotation shafts 31a and 32a to idle when a torque equal to or greater than a prescribed value is applied to the rotation shafts 31a and 32a of the reels 31 and 32. Thereby, a paper sheet storage mechanism can be provided that can wind tape while preventing the tape from becoming loose while maintaining a certain level of tension of the tape even when the amount of stored paper sheets has increased or when the speed of winding is high.

According to the control method of the paper sheet storage mechanism of an embodiment of the present invention, the angular velocities of the reels 31 and 32 and the drum 10 are controlled in such a manner that the tape speed is constant in response to a state in which the pieces of tape 2a and 2b have been wound on the reels 31 and 32 and the drum 10. Thereby, the slippage amount of the torque limiter 35 is minimized, leading to a longer lifetime of the torque limiter 33.

(Variation Example)

In the explanations of the paper sheet storage mechanism and the control method therefor according to an embodiment of the present invention, a mechanism has been described in which the reels 31 and 32 include the torque limiter 33 that causes the reels 31 and 32 to idle when a torque equal to or greater than a prescribed value is applied to the rotation shafts 31a and 32a; however it is also possible to employ a configuration in which the rotation shafts 31a and 32a of the reels are connected to the reels 31 and 32 via a one-way clutch (not illustrated), and when the drum 10 winds the pieces of tape 2a and 2b, it is halted by being locked so as to cause tension in the pieces of tape 2a and 2b.

Also, when the drum winds tape, tension can also be caused in the pieces of tape 2a and 2b by the reel driving source 40 being stopped in a holding excitation manner.

Further, by also performing control of rotations when the drum winds paper sheets, similarly to the case of rewinding, it is also possible to perform control of the rotations at a speed slightly lower than the actual measurement value of the number of the rotations of the reels when the drum is winding paper sheets.

Note that while an example in which a pair of pieces of tape are used for winding and feeding out the banknotes 1 is explained in the present embodiment, the scope of the invention is not limited to this example, and a piece of tape may be used for winding and feeding out the banknotes 1. Also, while one reel driving source is used in the example, a driving source may be provided for each reel.

While the embodiment of the present invention has been explained, the present invention is not limited to the above embodiment, and various configurations or embodiments may be employed without departing from the spirit of the present invention.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A paper sheet storage mechanism that sandwiches a paper sheet between pieces of tape and stores the paper sheet, the paper sheet storage mechanism comprising:
a drum configured to wind the paper sheet sandwiched between the pieces of tape so as to store the paper sheet or to rewind the stored paper sheet so as to feed out the paper sheet;
a drum driving source configured to rotatably drive the drum;
a reel configured to feed out the tape when the drum winds the paper sheet and to wind the tape fed out from the drum when the paper sheet is fed out from the drum;
a reel driving source configured to rotatably drive the reel;
a tape speed detection unit configured to detect a speed of the tape; and
a drum control unit configured to control the drum driving source in accordance with information from the tape speed detection unit, wherein
the reel includes a reeling speed detection unit that detects at least one reeling speed, and a reel control unit that controls the reel driving source when storing or feeding out the paper sheet, and
the reel includes, in a reel rotation shaft, a torque limiter that idles when a torque equal to or greater than a prescribed value is applied.

2. The paper sheet storage mechanism according to claim 1, wherein
the drum control unit controls the drum driving source in such a manner that a tape speed detected by the tape speed detection unit is constant.

3. The paper sheet storage mechanism according to claim 1, wherein
the reel control unit controls the reel driving source in such a manner that the reeling speed detected by the reeling speed detection unit is lower than the tape speed when storing the paper sheet.

4. The paper sheet storage mechanism according to claim 1 wherein
the reel control unit controls the reel driving source in such a manner that the reeling speed is higher than the tape speed when feeding out the paper sheet.

5. A control method for a paper sheet storage mechanism, the control method comprising:
a drum driving source rotatably drives a drum in a direction in which a paper sheet is sandwiched between pieces of tape, is wound, and is stored; and
a drum control unit controls the drum driving source in accordance with information from a tape speed detection unit that detects a speed of tape, wherein
when the drum winds the paper sheet
a reel driving source rotatably drives a reel in a direction of feeding out the tape,
a reel control unit controls the reel driving source in such a manner that a reeling speed is lower than the tape speed, the reeling speed being detected by a reeling speed detection unit that detects a speed of the reel, and
a torque limiter included in a reel rotation shaft of the reel causes the reel rotation shaft to idle when a torque equal to or greater than a prescribed value is applied to the reel rotation shaft.

6. The control method according to claim 5, further comprising
the drum driving source rotatably drives the drum in a direction of rewinding and feeding out a paper sheet that has been sandwiched between the pieces of tape and stored, wherein
when the drum feeds the paper sheet
the reel driving source rotatably drives the reel in a direction of winding the tape,
the reel control unit controls the reel driving source in such a manner that a reeling speed is higher than the tape speed, the reeling speed being detected by the reeling speed detection unit.
